(19) United States
(12) Patent Application Publication
(10) Pub. No.: US 2005/0087231 A1
(43) Pub. Date: Apr. 28, 2005

(54) Non-electronic, automatically controlled valving system utilizing expanding/contracting material

(76) Inventors: Larry C. Sanders, Cordova, TN (US); Thomas R. Williams, Durango, CO (US); Warner H. Stuart, Thatcher, ID (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/956,354

(22) Filed: Oct. 1, 2004

Related U.S. Application Data
(60) Provisional application No. 60/510,777, filed on Oct. 14, 2003.

(51) Int. Cl. F16K 31/36

(52) U.S. Cl. 137/489.5

(57) ABSTRACT

A valve system automatically controlled by an expanding/contracting material and method of dispersing fluid through valve system are provided. The expanding/contracting material may be a hydrophilic material, wherein providing fluid to the hydrophilic material causes it to expand and constrict a hose or tubes dispersing fluid to a designated area. The constriction of the hose or tubes prevents fluid from coming into contact with the hydrophilic material allowing for the hydrophilic material to dry and contract, thereby releasing the pressure from the hose or tubes.

### REFERENCE TO RELATED APPLICATIONS

This application claims the benefit of U.S. Provisional Application Ser. No. [to be determined] filed Oct. 1, 2003.

### FIELD OF THE INVENTION

The present invention relates to valve systems, and more particularly valve systems that meter and/or control fluids through a hose or tubes. More specifically, valve systems that meter and/or control fluids through a hose or tube by means of the expansion and/or contraction of a material, such as a selected polymeric hydrogel material.

### BACKGROUND OF THE INVENTION

Irrigation systems are typically controlled through a combination of electronic and mechanical devices such as timing devices and/or moisture sensors. Electronic timers may be used in conjunction with pressurized lines to meter water (e.g., home, agricultural irrigation systems.) These systems typically over-water the target areas and are very inefficient. More than 80% of water used in most irrigation systems is wasted due to run-off, evaporation or watering unnecessary soil.

Moisture sensors used in state-of-the-art electronics automatically turn watering systems on or off. However, electronics of this type are expensive and are not practical for controlling and directing water to targeted areas, such as individual areas or large areas, needing precise watering based on the moisture content of the soil. Systems that make use of electronic sensors also involve the use of electric current to transmit signals as well as to control the valves. The use of electric current can be dangerous and may not be practical in remote areas.

Hygrostatic irrigation, the swelling and shrinking of a material, to control fluid flow has also been disclosed. An example of this method is disclosed in U.S. Pat. No. 4,182,357 entitled “Method Of Controlling The Relative Humidity In A Soil Environment And Apparatus For Accomplishing Same”. The method was described as controlling the relative humidity of an environment to a pre-set value through the swelling and shrinking of a water-soluble or water-swellable material that obstructs or relieves, respectively, the flow of water in a water supply line to the controlled environment. The water-swellable material was said to typically include a hydrogel such as a solid gel derived from polyacrylamide and poly(vinyl alcohol) formulations. The hydrogel was said to be one that preferably provided compliant swelling to about 25 times its dry volume when in equilibrium with water at 100% humidity. It has also been suggested in the above described reference that an osmotic sensor-regulator valve can be buried in the soil among plant roots.

It is therefore an object of the present invention to provide an improved valve system that improves upon prior art designs and which eliminates the need for electronic controllers, timers or sensors. It is also an object of the present invention to simplify the sensor and water meter functions as it relates to a hydrophilic valve assembly design.

It is also a further object of the present invention to reduce water loss due to ineffective control systems to positively impact the environment as well as greatly reduce the amount of resources spend on reprocessing the runoff water in treatment plants.

It is also a further object of the present invention to affix an expansion/contraction valve at the beginning of a water line to serve as the master controller for a number of feeders or to affix the valve “in-line” to provide specific control for a specific potion of the overall system.

It is also an object of the present invention to disperse fluid in otherwise inaccessible areas where the use of electronic control systems would be inconvenient.

It is also a further object of the present invention to affix the valve system at strategic locations along a feed line to ensure distribution based on localized soil conditions and ensure distribution to exact locations.

### SUMMARY OF THE INVENTION

According to one aspect, the present invention provides an apparatus for the metering and/or control of fluids. According to another aspect, the present invention provides an apparatus for the metering and/or control of fluids through a hose or tubes; furthermore the apparatus may be a valve system.

According to another aspect, the present invention provides an apparatus for the metering and/or control of fluids through a hose or tubes by means of the expansion and/or contraction of a material and more particularly where the material itself expands and contracts.

According to another aspect, the present invention provides an expanding or contracting hydrophilic material that directly or indirectly adjusts a metering mechanism to regulate the flow of fluid as the moisture levels of a given environment, e.g. soil, change. Specifically, the metering mechanism may be a pinch plate, needle valve, ball valve, gate valve, diaphragm valve, bladder, etc.

According to another aspect, the present invention provides hydrophilic material that may be used to directly or indirectly crimp a hose or tubing and thereby control the fluid flow of the “dispersing fluid”.

According to another aspect, the present invention provides hydrophilic material that may be used to directly or indirectly affect the flow of a “dispersing” fluid through a hose or tube by applying a constrictive force.

According to another aspect, the present invention provides an expansion/contraction valve to direct fluid, e.g. water, to the exact location and depth desired by a specific application.

According to another aspect, the present invention provides an expansion/contraction valve that can be attached to various points of a water or irrigation system to optimize the distribution of water (e.g., placement at the beginning or strategic locations of a water line for use as a master controller or as further distribution regulators.)

According to another aspect, the present invention provides an in-line device to meter varying quantities of water on individual feed lines stemming from a main feed line. This allows for variance in the flow levels stemming from a main line and more specifically allows for the monitoring and flow control to be placed in the correct position and depth so that the moisture content of desired location, (e.g., soil or root systems) is detected and an appropriate amount of water is metered by the individual feed lines. Furthermore, the system may be modified to deliver fluids to, but not limited to, individual plants, crops or trees. Furthermore, the system may be modified so that fluid can be dispersed above soil or below soil levels.

According to another aspect, the present invention provides a device to meter varying quantities of fluids other than water, including any Newtonian or non-Newtonian fluids and including but not limited to, all liquids and gases. Furthermore, the present invention provides a valve system that may be used to meter and disperse fluids including but not limited to herbicides, pesticides, fungicides, etc.

According to another aspect, the present invention may utilize an effecting fluid that contacts the expanding/contracting material, having a correlative relationship to the fluid to be dispersed. More specifically, these effecting fluids may be applied to the expanding/contracting material when fluids including, but not limited to, solvents, oils, etc. need to be dispersed.

According to another aspect, the present invention provides a valve system that may be used in irrigation systems including, but not limited to, agricultural systems, gardens, nurseries, farming and crop applications, landscaping golf courses, etc.

According to another aspect, the present invention provides a valve system that may be used in fluid leveling systems including but not limited to livestock water containers, aquariums, fish ponds, etc.

According to another aspect, the present invention may be attached or manufactured as an integral part of a fluid containing system, whereby the dispersing fluid is housed in a containment vessel, above, on top of, or under the ground and a valve system is utilized to control the appointment of the “dispersing” fluid to a designated area.

According to another aspect, the present invention provides that the expansion/contraction material can be chemically formulated and designed with absorption and retention properties of a fluid to simulate typical soil, or near surface conditions.

According to another aspect, the present invention provides that the pressure of the fluid entering the hydrophilic material may be adjusted in the valve.

According to another aspect, the present invention provides that the flow of fluid to the valve and thus the hydrophilic material may be regulated by a constrictive screw located in the by-pass line providing fluid to the valve.

According to another aspect, the present invention provides a valve design that is intended to, through one or a plurality of cycles, deliver a measured quantity of water to one or a plurality of drip nozzle each time the valve cycles. The cycle frequency in the valve may be determined by the surrounding air temperature and relative humidity. Furthermore, at higher the temperatures and lower humidity, the valve cycle may assume a higher cycle frequency than lower temperatures and greater humidity. More specifically, the valve may be placed in direct sunlight at a position of approximately 6 inches above the ground.

According to another aspect, the present invention provides a method for the metering and/or control of fluids through a hose or tubes by means of an expanding and/or contracting material.

According to another aspect, the present invention provides a method for the metering and/or control of fluids through a hose or tubes by means of a hydrophilic material that directly or indirectly adjusts a control valve to dictate the fluid flow as the moisture level of the soil changes.

### BRIEF DESCRIPTION OF THE DRAWINGS

Features and advantages of the present invention are set forth herein by description of embodiments consistent with the present invention, which description should be considered in conjunction with the accompanying drawings, wherein:

FIG. 1 is a schematic drawing of an apparatus that may be used to meter and/or control fluids through a hose or tubes.

### DESCRIPTION OF PREFERRED EMBODIMENTS

The present invention relates to a valve system to meter and/or control fluids. The valve system utilizes a hydrophilic material to control the flow of liquid through the valve. The valve system also preferably uses a by-pass line to supply the hydrophilic material with fluid for expansion and is self-hydrating. Contraction of the hydrophilic material may be governed by the evaporation of the fluid from the hydrophilic material through openings such as radial pores in the hydrophilic chamber.

Consistent with the present invention, the hydrophilic material can be used to directly or indirectly to apply a constrictive force to affect the flow of a “dispersing” fluid through a hose or tube. The expansion or constriction force of the material will open, close or adjust a valve assembly that in turn will control the rate of flow and/or direction of the dispersing fluid. The hydrophilic material may also be used to crimp a hose or tubing and thereby control the “dispersing” fluid flow. Further, the expansion and contracting material may be incorporated into the design of the valve assembly so that when the material swells and contracts it directly or indirectly influences a metering mechanism. The metering mechanism includes, but is not limited to, a needle valve, ball valve, gate valve, diaphragm valve or bladder.

It should also be appreciated that the fluids metered and dispersed may be any Newtonian or non-Newtonian fluid (and include, but are not limited to, all liquids and gasses.) Fluids dispersed may include, but are not limited to, water, herbicides, pesticides, fingicides, etc. An effecting fluid may also be used to contact the expansion/contraction material when fluids such as solvents, oils, etc. need to be dispersed.

Accordingly, the present invention is directed at a valve for delivery of fluid to one or a plurality of outlets wherein said valve comprises a valve body comprising first and second sections including a fluid inlet tube in communication with one or a plurality of fluid outlets and a fluid bypass tube in communication with said first section of said valve body. The first section of said valve body includes a chamber to accommodate fluid including a valve assembly comprising a spring in communication with a diaphragm which spring and diaphragm controls the flow of fluid to said second section in response to a fluid pressure in said first section of said valve body. The second section in fluid communication with said first section includes a chamber to accommodate fluid swellable material wherein said fluid swellable material is itself in communication with said fluid inlet tube and wherein said fluid swellable material upon expansion or contraction regulates the flow of fluid from said fluid inlet to said one or plurality of outlets. The second section can include one or a plurality openings to allow said fluid in said second section to escape from said second section.

The second section of said valve may preferably include a plate with a protruding section wherein said protruding section is engaged to said fluid swellable material whereupon expansion of said fluid swellable material said material engages said plate and said protruding section engages said water inlet tube and constricts the flow of water in said water inlet tube.

The aforementioned valve may optionally include a third section which itself accommodates or houses said fluid by-pass tube and wherein said third section itself includes a constriction device in communication with said bypass tube to regulate the flow of fluid in said bypass tube. Accordingly, the first, second and third sections of said valve may be mechanically connected to one another or may be of unitary construction.

In method form, the present invention may be described as a method for regulating the flow of fluid to an environment which comprises providing a valve body comprising first and second sections including a fluid inlet tube in communication with one or a plurality of fluid outlets and a fluid bypass tube in communication with said first section of said valve body. One can then introduce fluid in said fluid inlet tube wherein said fluid passes to said fluid outlets and to said fluid bypass tube, followed by introducing fluid from said fluid bypass tube to said first section of said valve body wherein said fluid develops a pressure in said first section of said valve body wherein said first section of said valve body includes a first valve which responds to said pressure to thereby regulate the flow of fluid to said second section of said valve body. This is then followed by introducing fluid into said second section of said valve body which includes a chamber to accommodate fluid swellable material wherein said fluid swellable material is in communication with said fluid inlet tube and wherein said fluid swellable material operates to regulate the flow of fluid from said fluid inlet to said one or plurality of outlets.

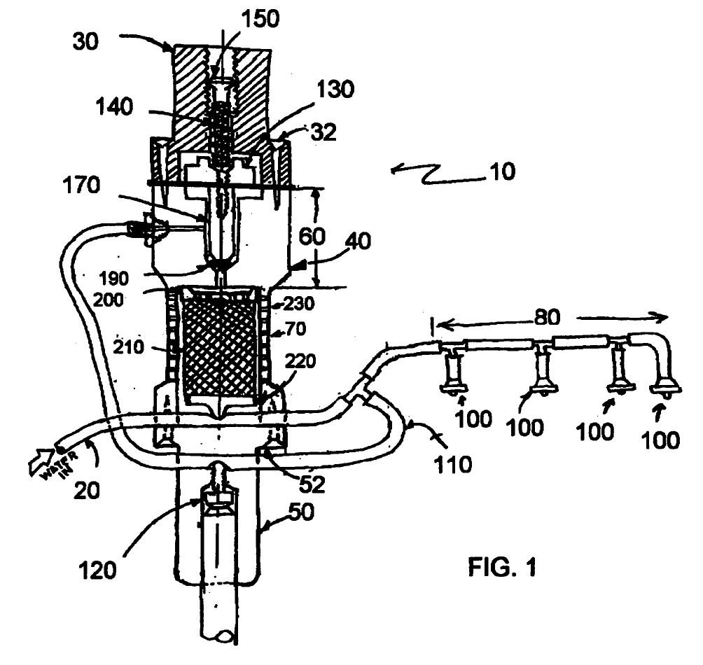

Turning to FIG. 1, a preferred valve system 10 is illustrated to meter and/or control fluids through a conduit or hose or tube 20. The apparatus 10 may generally include a first or top body 30, a second or center body 40 and optionally a third or bottom body 50. The third body 50 may be buried under ground with the first body 30 and second body 40 remaining above ground. More preferably, the apparatus 10, including the first body 30, the second body 40 and the third body 50, is above ground. The center body 40 may also generally include a bleed valve assembly 60 and a hydrophilic chamber 70.

The fluid to be metered, (e.g. water, fungicide, herbicide, etc.) enters valve body 10 through fluid inlet 20 through hose or tubing 20. Preferably the water pressure entering the apparatus 10 is above zero and at or less than 45 psi or 310 kPa. The hose or tubing 20 may preferably be formed out of flexible material including, but not limited to, rubber or silicone. The hose or tubes 20 communicates with an outlet region 80. The outlet region 80 may be a single outlet or a drip manifold with a single or a plurality of flow control drip nozzles 100. The outlet region 80 may be placed in the soil near the root system, above ground or anywhere in an agricultural field.

The hose or tubes 20 also preferably communicate with a by-pass tube 110, which may also be formed out of flexible material including, but not limited to, rubber or silicone. The by-pass tube 110 may pass through the valve body 10, preferably in the bottom body 50. A constriction device 120, e.g. an adjusting screw, may be used as a pinch valve to adjust the flow of fluid in the by-pass tube 110. The by-pass tube 110 then communicates with the bleed valve assembly 60 in the valve body 10, preferably located in the center body 40.

Fluid communicated by the by-pass tube 110 enters the bleed valve assembly 60 and may apply pressure to the diaphragm push plate 130. When sufficient pressure is reached, diaphragm push plate 130 overcomes the force of the compression spring 140 and raises the bleed valve stem 170 from its seat 190. The compression spring 140 force may be adjusted using the compression spring screw 150 to control the pressure necessary to unseat the valve stem 170. The seat 190 is preferably constructed of an “o-ring” or other suitable materials to provide a seal to prevent the seepage of the pressurized fluid when the valve stem 170 is not under pressure.

Once the valve stem 170 is raised from its seat 190, the fluid to be metered flows over and through a distribution plate 200 into and around the hydrophilic chamber 70 containing a hydrophilic material 210. As the hydrophilic material 210 absorbs the fluid it expands and exerts a force on the metering mechanism 220, e.g. the pinch plate. The metering mechanism 220 then constricts the hose or tubes 20 providing fluid to the outlet 80 and by-pass tube 110.

Once fluid in the by-pass tube 110 is constricted, flow to the hydrophilic material 210 is also constricted. Radial holes 230 in the hydrophilic chamber 70 allow for fluid to escape from the hydrophilic material by vaporization. As the hydrophilic material 210 dries it begins to shrink, slowly releasing the force against the metering mechanism 220 and releasing the constriction on the hose or tubes 20. Fluid may then flow through the hose or tubes 20 to initiate a new cycle.

As illustrated, the valve system 10 may be of an assembled construction, for example, as illustrated the first body 30 is engaged to the second body 40 via use of screws 32, which may preferably be brass type screws or other similar type of material. As illustrated, second body 40 is attached to body 50 via screws 52. It can be appreciated, however, that third body section 50 may be of unitary construction with second body 40. In addition, first valve body 30 and second valve body 40 and third valve body 50 may be of unitary construction. In addition, the valve system 10 herein may be conveniently manufactured from plastic material via melt processing techniques, such as injection molding or compression molding.

It should also be appreciated that it is contemplated that the valve system herein can be configured to introduce rainwater to the hydrophilic material, whereby the rainwater is communicated to the hydrophilic material. Preferably, the rainwater may be supplied to the hydrophilic material in the hydrophilic chamber 70. More preferably, the rainwater may be collected in a reservoir in communication with the hydrophilic chamber. In such fashion, it can be appreciated that by supplying rainwater to the hydrophilic chamber 70 the invention herein provides another technique for providing a self-hydrating valve system for fluid delivery. For example, rainwater might be collected within first section 30 and routed into hydrophilic chamber 70. Accordingly, by directing rainwater to the hydrophilic chamber 70, either alone or in combination with second body section 40, a self hydrating valve system 10 is provided.

It should be appreciated that a number of hydrophilic materials may be used in the present invention. Preferably, a hydrophilic polyurethane type material is employed in this invention. Such hydrophilic type materials include but are not limited to acrylics and other polymer materials which absorb water at levels up to about 50-100% (weight) while maintaining structural integrity to serve as a valve component in the present invention. Most preferably, the hydrogel may also absorb other organic compounds with hydrophilic or hydroxy based functional groups. More preferably, the hydrogel can swell to two or more times its original volume.

The foregoing description is provided to illustrate and explain the present invention. However, the description hereinabove should not be considered to limit the scope of the invention as set forth in the claims appended hereto.

1. A valve for delivery of fluid to one or a plurality of outlets wherein said valve comprises:
(a) a valve body comprising first and second sections including a fluid inlet tube in communication with one or a plurality of fluid outlets and a fluid bypass tube in communication with said first section of said valve body;
(b) said first section of said valve body includes a chamber to accommodate fluid including a valve assembly comprising a spring in communication with a diaphragm which spring and diaphragm controls the flow of fluid to said second section in response to the fluid pressure in said first section of said valve body;
(c) said second section in fluid communication with said first section including a chamber to accommodate fluid swellable material wherein said fluid swellable material is in communication with said fluid inlet tube and wherein said fluid swellable material upon expansion or contraction regulates the flow of fluid from said fluid inlet to said one or plurality of outlets.

2. The valve of claim 1 wherein said second section includes one or a plurality openings to allow said fluid in said second section to escape from said second section.

3. The valve of claim 1 where said second section includes a plate with a protruding section wherein said protruding section is engaged to said fluid swellable material whereupon expansion of said fluid swellable material said material engages said plate and said protruding section engages said water inlet tube and constricts the flow of water in said water inlet tube.

4. The valve of claim 1 further including a third section which accommodates said fluid by-pass tube and wherein said third section includes a constriction device in communication with said bypass tube to regulate the flow of fluid in said bypass tube.

5. The valve of claim 1 wherein said first and second sections of said valve are mechanically connected to one another.

6. The valve of claim 1 wherein said first and second sections of said valve are of unitary construction.

7. The valve of claim 4, wherein said first, second and third sections of said valve are mechanically engaged to one another or of unitary construction.

8. A valve for delivery of fluid to one or a plurality of outlets wherein said valve comprises:
(a) a valve body comprising first and second sections including a fluid inlet tube in communication with one or a plurality of fluid outlets and a fluid bypass tube in communication with said first section of said valve body,
(b) said first section of said valve body includes a chamber to accommodate fluid including a first valve which first valve regulates flow of fluid to said second section in response to fluid pressure in said first section of said valve body;
(c) said second section in fluid communication with said first section including a chamber to accommodate fluid swellable material wherein said fluid swellable material is in communication with said fluid inlet tube and wherein said fluid swellable material upon expansion or contraction regulates the flow of fluid from said fluid inlet to said one or plurality of outlets.

9. A method for regulating the flow of fluid to an environment which comprises:
(a) providing a valve body comprising first and second sections including a fluid inlet tube in communication with one or a plurality of fluid outlets and a fluid bypass tube in communication with said first section of said valve body,
(b) introducing fluid in said fluid inlet tube wherein said fluid passes to said fluid outlets and to said fluid bypass tube;
(c) introducing fluid from said fluid bypass tube to said first section of said valve body wherein said fluid develops a pressure in said first section of said valve body wherein said first section of said valve body includes a first valve which responds to said pressure to thereby regulate the flow of fluid to said second section of said valve body;
(d) introducing fluid into said second section of said valve body which includes a chamber to accommodate fluid swellable material wherein said fluid swellable material is in communication with said fluid inlet tube and wherein said fluid swellable material operates to regulate the flow of fluid from said fluid inlet to said one or plurality of outlets.

10. The method of claim 9 wherein said fluid swellable material comprises a polymeric material.

11. The method of claim 9 wherein the flow of fluid in said fluid bypass tube is regulated prior to introduction into said first section of said valve body.
